(19) United States
(12) Patent Application Publication
(10) Pub. No.: US 2025/0377292 A1
(43) Pub. Date: Dec. 11, 2025

(54) ANALYTICAL DEVICE FOR DETERMINING A PARAMETER OF A MEDIUM, SENSOR ADAPTER AND METHOD FOR PRODUCING SAME

(71) Applicant: Nova Industrial Analytics GmbH, Eschach (DE)

(72) Inventor: Joachim MANNHARDT, Eschach (DE)

(73) Assignee: Nova Industrial Analytics GmbH, Eschach (DE)

(21) Appl. No.: 19/302,451

(22) Filed: Aug. 18, 2025

Related U.S. Application Data
(63) Continuation of application No. PCT/EP2024/053902, filed on Feb. 15, 2024.

(30) Foreign Application Priority Data
Feb. 16, 2023 (DE) 10 2023 103 787.0

(51) Int. Cl. G01N 21/31

(52) U.S. Cl. CPC G01N 21/31; G01N 2201/021; G01N 2201/0231

(57) ABSTRACT

A sensor adapter for providing electrical, optical, electro-optical and/or pneumatic connection elements which can be connected to components of a measuring assembly accommodated in a housing, and via which the measuring assembly can be coupled to a process environment. The connection elements are integrated in connection modules which are fixed in position in a fixing element in the interior of the sensor adapter. The connection modules are advantageously part of a modular system of standardized components.

This nonprovisional application is a continuation of International Application No. PCT/EP2024/053902, which was filed on Feb. 15, 2024, and which claims priority to German Patent Application No. 10 2023 103 787.0, which was filed in Germany on Feb. 16, 2023, and which are both herein incorporated by reference.

### BACKGROUND OF THE INVENTION

### Field of the Invention

The invention relates to an optical analysis device for determining a characteristic of a medium. The invention further relates to a sensor adapter for optical, electrical and/or pneumatic coupling of the analysis device to a process environment, and to a production method for such a sensor adapter.

### Description of the Background Art

In many sectors of the production and further-processing industry, optical measurement methods are used to evaluate the state or quality of a product or of an intermediate product. The term “optical measurement method” is to be understood in the following text to mean a measurement method using electromagnetic radiation, in particular electromagnetic radiation in a spectral range between infrared and ultraviolet. “Optical measurement” thus includes in particular a measurement in the far infrared (FIR) spectrum, mid infrared (MIR) spectrum, near infrared (NIR) spectrum, in the visible spectrum and in the UV range.

The chemical and the pharmaceutical industry and food production utilize optical, in particular spectroscopic, analysis systems via which, in a production environment and using a probe, measurements are carried out throughout the process on a measurement-fluid variable acquirable by optics. For example, use can be made of an immersion probe dipped into the measurement fluid, which is carried in a reaction vessel or a tube. Via the immersion probe, a measurement beam emitted by a radiation source is guided through the measurement fluid over a measurement section and then directed onto a detector, in which the intensity, spectrum, etc. of the measurement radiation influenced by the measurement fluid are analyzed. The results provide information about state variables (e.g. concentration, density etc.) of the measurement medium.

A measuring arrangement suitable for such measurements comprises a radiation source, a detector and a controller combined in a housing. If the optical analysis system is to be used in a process environment, the housing enclosing the measuring arrangement must be robustly designed, in order to protect the measuring arrangement against temperature influences, dirt, dust, jolts, etc. A measuring arrangement comprising such a housing is known from DE 10 2012 019 433 A1, which corresponds to US 2014/0097347, which is herein incorporated by reference. The interior space of the housing contains a sensor device and an electronics device spatially separate therefrom.

Further, the international application WO 2022/223425 A1 discloses an optical analysis device which can be attached to a process environment via a sensor adapter. The sensor adapter comprises a tube, inside which electromagnetic radiation from the radiation source is irradiated onto the measurement medium in the process environment and measurement radiation from the measurement medium can be directed back onto the sensor device.

### SUMMARY OF THE INVENTION

An object of the present invention is to further develop the coupling, known from WO 2022/223425 A1, which corresponds to US 2024/0060873, which is incorporated herein by reference, of the measuring arrangement to a process environment in such a way that not only electromagnetic radiation, but also electrical signals, media (for example compressed air, inert gas), etc. can be exchanged between measuring devices. To this end, the intention is to provide a sensor adapter which allows a wide range of different measurement situations and via which the measuring arrangement can be pressure-tightly and gastightly shielded from the process environment.

Such a sensor adapter for connecting a plurality of sensors and/or actuators of different types located in a process environment to a measuring arrangement received in a housing must, on its side facing the process environment, provide-depending on the application-electrical, optical, electro-optical and/or pneumatic connection elements (e.g. plugs, bushings, sockets, etc.) to which the associated connection lines (wires, cables, light guides, hoses, etc.) in the process environment can be fastened. According to the invention, these connection elements are integrated in connection modules which, during the production of the sensor adapter, are inserted into a fixing element and positionally fixed there. This fixing element is then arranged in the interior space of the sensor adapter, aligned there in a desired position, and fixed in this position by at least partially filling the interior space of the sensor adapter. The positional alignment can be effected via a mounting aid placed onto the end of the sensor adapter.

The fixing element can receive multiple connection modules. It combines the connection modules and thus represents an auxiliary device for the positioning and fixing of the connection modules in the interior space of the sensor adapter. In this case, the fixing element is a universal element that can be utilized for any desired applications. The connection modules received in the fixing element, by contrast, are individually adapted to the respective measurement situation. Advantageously, the connection modules are part of a modular system of standard components, so that, for a specific application, the connection modules required by that application are taken out of the kit, inserted into the fixing element and integrated together in the interior space of the sensor adapter. In order to provide such a modular system, the individual connection modules preferably all have the same width, which corresponds to the width of a receiving region in the fixing element. Therefore, a standard fixing element can receive a multiplicity of different combinations of connection modules.

In particular, the sensor adapter according to the invention allows straightforward coupling and decoupling of sensors and/or measuring heads.

To mechanically attach the sensor adapter to a housing of the measuring arrangement, the sensor adapter is advantageously provided with a connection plate with which it can be screwed onto the housing. The sensor adapter advantageously further comprises an end flange for mechanical attachment of the sensor adapter to a process environment. In order to thermally shield the measuring arrangement from the process environment, the sensor adapter can be provided with a cooling device. This cooling device expediently comprises a cooling line through which a coolant can flow and which annularly surrounds an outer wall of the sensor adapter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective exterior view of an optical analysis device according to an example of the invention, comprising a sensor adapter;

FIG. 2 shows a schematic partial sectional view of the analysis device in FIG. 1;

FIG. 3a shows a sectional view of a sensor adapter for a spectroscopic application;

FIG. 3b shows a sectional view of a sensor adapter for an application using light guides and electric cables;

FIG. 4a shows a plan view of a fixing frame to be fastened in the interior space of the sensor adapter;

FIG. 4b shows a plan view of different connection modules that can be received in the fixing frame of FIG. 4a;

FIG. 4c shows a perspective view of a fixing element comprising a fixing frame and three connection modules received therein;

FIGS. 5a to 5d show individual steps in the production of the sensor adapter. FIG. 5a shows a fixing element with connection modules and connected lines. FIG. 5b shows a sensor adapter with a fixing element inserted. FIG. 5c shows a sensor adapter with a mounting aid placed on. FIG. 5d shows a sensor adapter after pouring in the potting compound.

FIG. 6 shows a perspective view of the sensor adapter with a mounting aid placed on.

### DETAILED DESCRIPTION

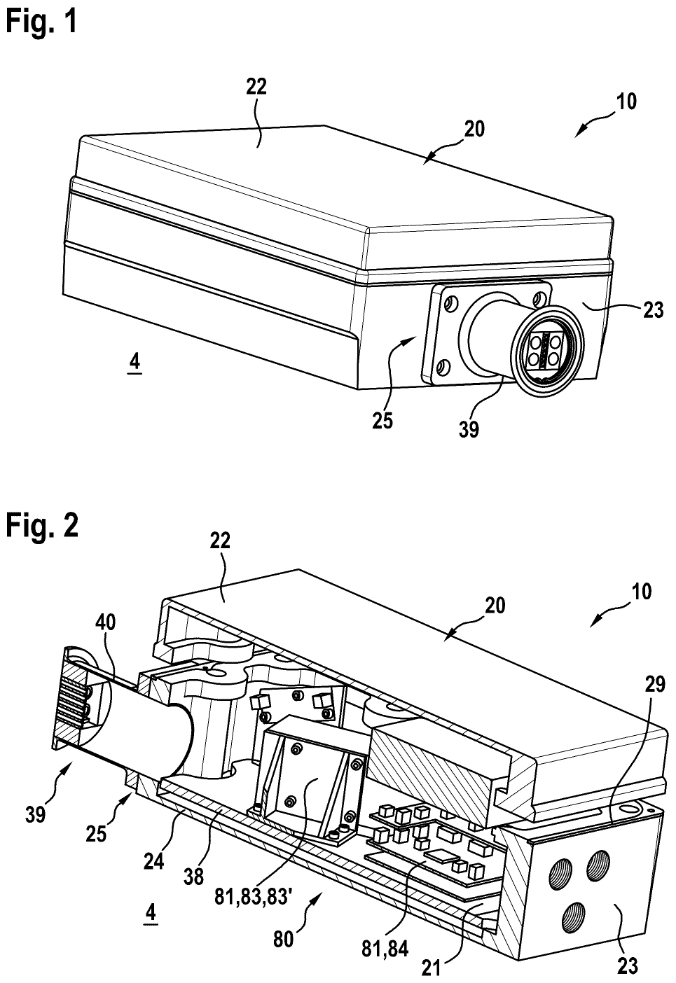

FIG. 1 shows a perspective exterior view and FIG. 2 shows a partial sectional view of an analysis device 10 for determining at least one characteristic of a measurement medium using an optical, electronic, electro-optical and/or electro-mechanical method. In the present case, the analysis device 10 comprises a housing 20 containing a measuring arrangement 80 with a plurality of components 81. The measuring arrangement 80 shown here comprises in particular a radiation source (not illustrated in the partial sectional view of FIG. 2), a detector 83 (in the present case a spectrometer 83′) and a controller 84, and can also contain further optical, electronic, electro-optical and/or electro-mechanical components 81. The controller 84 serves, among other things, to coordinate the timing between the spectrometer 83′ and the radiation source and can also perform further control and evaluation functions, e.g. taking the signals from the spectrometer 83′ as a basis to calculate a spectrum or a process parameter and forwarding measurement results, for example via ethernet or a process interface, to an exterior space 4 located outside the housing 20.

The housing 20 is formed in two parts and comprises a top shell 22 and a bottom shell 23 connected to one another by a detachable connection, for example a screw connection. The bottom shell 23 is provided underneath with a base plate 24, in the region of which there can be a cooling device for controlling the temperature of the measuring arrangement 80. The bottom shell 23 has a connection region 25 to which a sensor adapter 39 (described in more detail later on) is fastened. Via this sensor adapter 39, the measuring arrangement 80 in the interior space 21 of the housing 20 can be mechanically, electrically and optically connected to a process environment 5 and media and data can be exchanged between the analysis device 10 and a measurement medium located in the process environment. The housing 20 further has through-holes 75 for media, power and/or signal cables serving to supply media and energy and for external data exchange of the optical, electrical, electro-optical and electro-mechanical components 81 located in the housing 20.

In the assembled state shown in FIG. 1, the two housing shells 22, 23 enclose a closed cavity 21 in which a measuring arrangement 80 can be completely received. Between the top shell 22 and the bottom shell 23 there may be a peripheral seal 29, for example an O ring or a flat seal made of plastic or metal, via which the interior space 21 of the housing 20 can be hermetically closed off; this is advantageous in particular when the analysis device 10 is to be used in a contaminated or potentially explosive process environment.

The interior space 21 of the housing 20 contains a component support 38 on which the components 81 of the measuring arrangement 80 are fastened. The component support 38 is connected to the bottom shell 23 of the housing 20 detachably, for example via a screw connection. Such a detachable connection of the component support 38 to the bottom shell 23 allows the component support 38 currently in use to be replaced by a different component support (of the same or a different design); furthermore, differently fitted component supports 38 can be utilized, and therefore one and the same housing 20 can be used to receive different measuring arrangements 80.

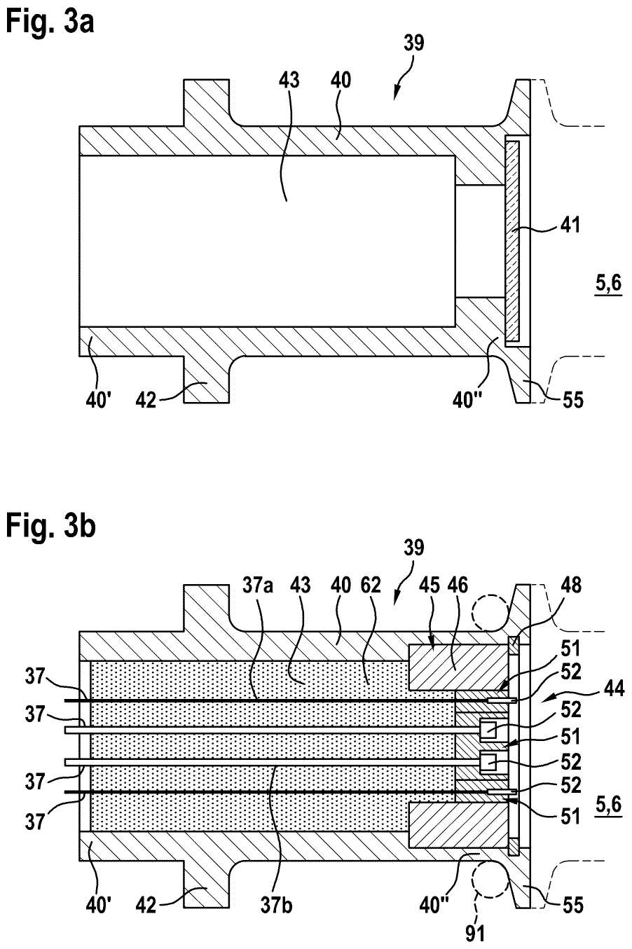

The sensor adapter 39 located in the connection region 25 serves, in the present example, for discharging excitation pulses (e.g. excitation radiation) into the process environment and for introducing measurement pulses (e.g. radiation reflected by the measurement medium) into the housing interior space 21. Sectional views of the sensor adapter 39 for two different use cases are illustrated in FIGS. 3a and 3b. The sensor adapter 39 comprises a tubular adapter housing 40, of which the end 40′ facing toward the measuring arrangement 80 is provided with a connection plate 42 to be fastened to the housing 20 of the measuring arrangement 80. The end 40″ facing away from the housing 20 is provided with an annularly encircling terminating flange 55. Via this terminating flange 55, the sensor adapter 39 can be fastened to a counterpart (not shown in FIGS. 3a and 3b) in the process environment 5, for example to a vessel carrying the measurement medium 6, using a clamp connection, in particular a tri-clamp connection.

For a given measurement task with the measuring arrangement 80 necessary therefor and with the associated lines 37, it is necessary to provide a dedicated sensor adapter 39 which integrates the lines, hoses etc. necessary for the measurement task and ensures that the process environment 5 and the housing interior space 21 can be decoupled reliably in terms of the process. In the simplest case, the sensor adapter 39 is used for a measurement task in which exclusively electromagnetic radiation is discharged from the housing interior space 21 and introduced into the process environment, and thus in which it is not necessary to route cables or media lines through the sensor adapter into the process environment 5. In this case, that end 40″ of the sensor adapter 39 that faces away from the measuring arrangement 80 may have attached to it a mechanical seal, for example a window 41 transparent to the radiation used, which avoids dust or dirt from penetrating into the interior space 21 of the housing 20. Depending on the spectral range used, a window 41 made of glass, quartz, sapphire, etc. can be utilized.

More complex applications require—in addition to or instead of the introduction and discharge of electromagnetic radiation-further sensor systems, for example temperature measurements, flow measurements, etc. For this, it is necessary to integrate, in an interior space 43 of the adapter housing 40, lines 37 (electric lines, light guides, pneumatic lines etc.) via which the components 81 (e.g. spectrometers, radiation sources, microprocessors, etc.) of the measuring arrangement 80 can interact with the process environment 5 and/or the measurement medium 6 located there (see FIG. 3b). For instance, it is possible for the interior space 43 of the adapter housing 40 to contain electric lines 37a, for example lines for connecting sensors which acquire process variables or environmental information (temperature, flow velocity, leaks, etc.) of the measurement medium 6 and/or of the process environment 5. If, furthermore, measurements are to be carried out on the measurement medium 6 via electromagnetic radiation, the sensor adapter 39 additionally serves to receive light guides 37b for introducing and discharging optical radiation into and from the process environment 5. If pneumatic actuators are to be actuated in the process environment 5, the associated compressed-air lines are also routed in the interior space 43 of the sensor adapter 39. Furthermore, control lines can also be provided in order to exchange control signals between the controller 84 in the housing interior space 21 and actuators in the exterior region 4 of the housing 20, e.g. to control an automated measurement of the white level.

All of the lines 37 (light guides, pneumatic lines, data and control lines, etc.) routed through the sensor adapter 39 must be provided with suitable (optical, electrical, pneumatic, etc.) connection elements 52 in an outlet region 44 of the sensor adapter 39 that faces toward the process environment 5, in order to make it possible, when the optical analysis device 10 is being taken out of the process environment 5, to straightforwardly and quickly disconnect the lines 37 routed in the interior space 43 of the sensor adapter 39.

An advantage of the solution according to the invention is that, for adapting the analysis device 10 to a wide variety of measurement tasks, the two-part housing 10 does not need to be opened.

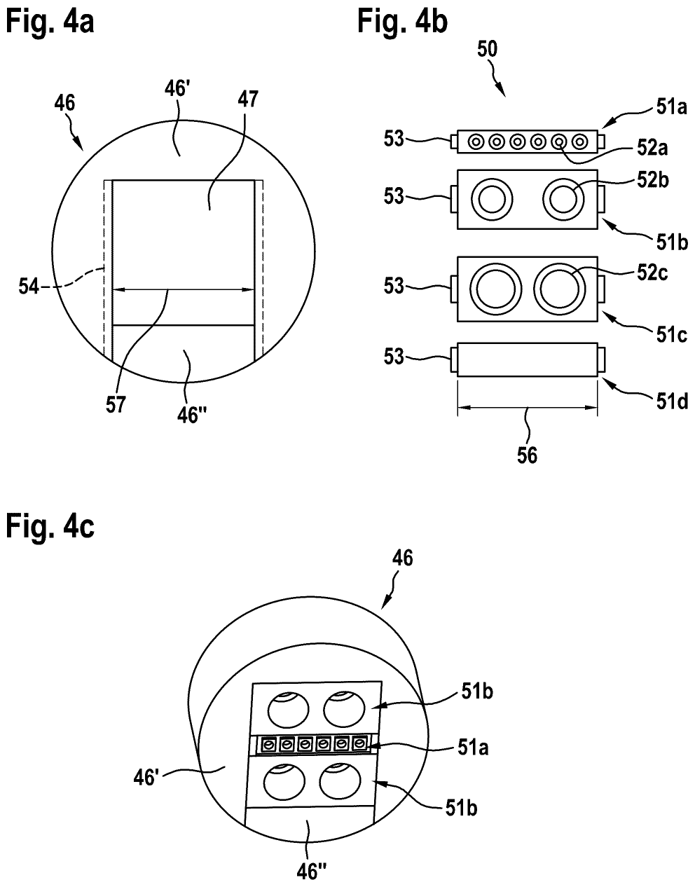

In order to route a variety of different lines 37 through the interior space 43 of the sensor adapter 39 and positionally accurately position the connection elements 52 associated with these lines 37, at the end facing toward the process environment 5 the interior space 43 of the adapter housing 40 contains a fixing element 45 of which the outer contour is adapted to the inner contour 43 of the adapter housing 40 and, in the present example, has a cylindrical shape: see the perspective illustration in FIG. 4c. The fixing element 45 comprises a fixing frame 46 with a U-shaped main module 46′ and a terminating module 46″, between which the width 57 is formed in the cavity 47 (see FIG. 4a). This cavity 47 serves to receive connection modules 51 which are pushed into the main module 46′ and held in place via the terminating module 46″.

To mount sensor adapters 39 for the wide variety of applications, a modular system 50 of different standard connection modules 51 is provided, and from the modular system it is possible to select and assemble the components required for a given measurement task. The connection modules 51 of this modular system 50 differ in their functionalities and are each provided with specific connection elements 52 (electric plugs, light guide couplings, etc.) which allow a standard connection to an external line. The width 56 of the connection modules 51 is standard (and corresponds to the width of the cavity 47 in the fixing frame 46), but-depending on the functionality-their heights may differ. Some of them are illustrated by way of example in FIG. 4b: Connection module 51a comprises six pin contacts 52a for fixing/connection of six electric cables, connection module 51b comprises two sockets 52b for fixing/connection of two fiber-optic cables, and connection module 51c comprises two bushings 52c for fixing/connection of a pneumatic hose. To fill any gaps that arise in the fixing frame 46, the modular system 50 further comprises spacers 52d of various heights. The sides of the connection modules 52 are provided with projections 53 which engage in grooves 54 in the main module 46′ of the fixing frame 46 when the fixing frame is in the assembled state.

In the exemplary embodiment in FIG. 4c, the fixing frame 46 contains two connection modules 51b for connection of two respective light guides and a connection module 51a for connection of electric cables. The light guides serve for input/output coupling of electromagnetic radiation in two different spectral ranges. The electric lines serve e.g. for carrying out temperature measurements, flow measurements, etc.

To produce a sensor adapter 39 with the desired connection elements 52, the fixing frame 36 must be inserted into the sensor adapter 39 positionally accurately and the interior space 43 of the sensor adapter 39 must then be gas-tightly and pressure-tightly closed. This takes place in the following process steps:

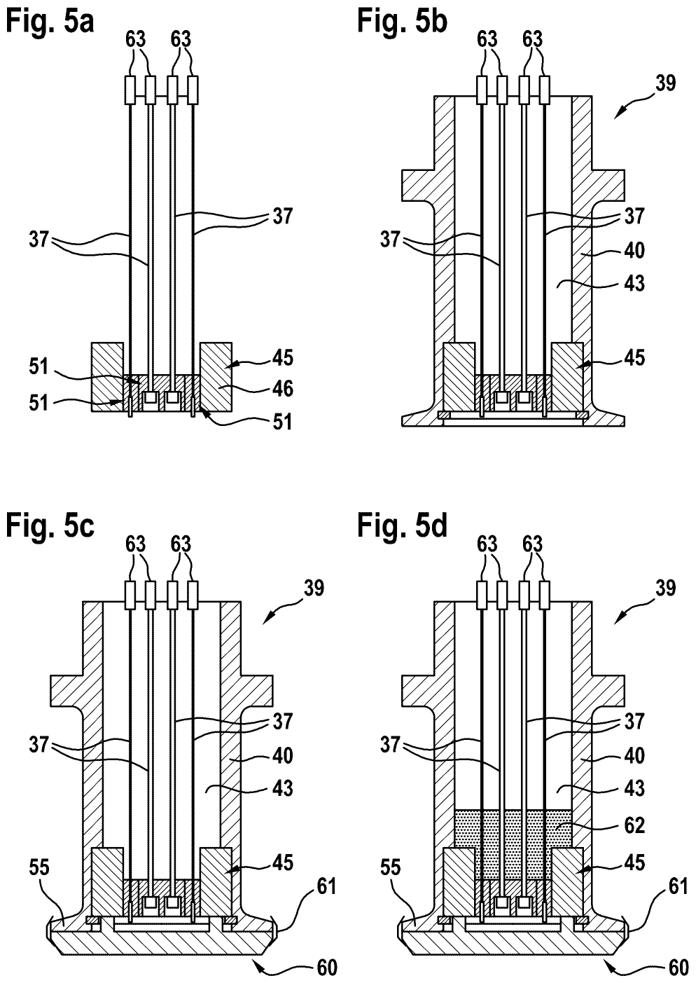

Firstly, connection modules 51 matching the desired connection elements 52 are selected, provided on one side with the associated lines 37 of the housing, and arranged in the fixing frame 46. The ends of the lines 37 remote from the fixing frame 46 are provided with sleeves 63 for later attachment of the lines 37 to the components 81 of the measuring arrangement 80 (step A: see FIG. 5a). Light guides must in this case be mounted in such a way that the distances between the end faces are matched to the wavelength range, since otherwise white-light interference can occur. The fixing element 45 produced in this way is plugged into the interior space 43 of the sensor adapter 39 and secured there with a spring ring 48 shown in FIG. 3b (step B: see FIG. 5b).

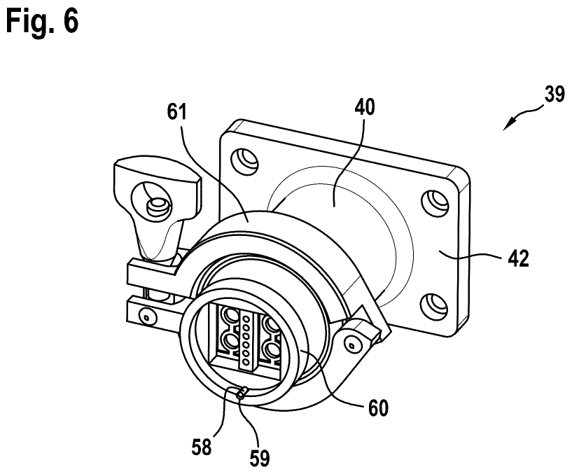

Then, the fixing element 45 is aligned, oriented and positioned in the desired position using a mounting aid 60 (FIG. 5c). The mounting aid 60 has the form of a ring which is placed onto the terminating flange 55 of the sensor adapter 39 and provided with a cutout 59, which engages in a projection 58 on the fixing frame 46 (see the perspective illustration in FIG. 6). By rotating the mounting aid 60, the fixing element 45 in the interior space 43 of the sensor adapter 39 can thus be rotated into the desired position and fixed in this alignment via a clamp 61.

Then, the interior space 43 of the sensor adapter 39 is filled at least in certain regions with a potting compound 62 (step C: see FIG. 5d). After the potting compound 62 has hardened, the fixing element 45 together with the connection modules 51 contained therein are fixed in the adapter housing 40 and any gaps existing between the inner wall of the adapter housing 40 and the outer wall of the fixing element 45 are sealed. As a result, in the assembled state of the sensor adapter 39 with the housing 20 of the measuring arrangement 80, the housing interior space 21 is pressure-tightly and gas-tightly closed with respect to the process environment 5. The mounting aid 60 can then be removed.

If the potting compound 62 has hardened, the rest of the interior space 43 of the adapter housing 40 is filled with further potting compound (see FIG. 3b); the fill level should at most reach the height of the sleeves 63, so that the sleeves 63 protrude out of the potting compound after the latter has hardened.

Lastly, the sensor adapter 39 is checked for tightness using a helium leak detector, and the lines 37 are checked for functional capability.

In this way, by using the modular system 50 of the connection modules 51, sensor adapters 39 can be produced for a wide variety of use cases. As described above, the sensor adapter 39 constitutes an (optical, electrical, etc.) interface between the measuring arrangement 80 in the interior space 21 of the housing 20 and the raw process environment 5. In addition, the sensor adapter 39 has the task of thermally shielding the temperature-sensitive components 81 in the interior space 21 of the housing 20 from the process environment 5, in which high temperatures and/or considerable temperature fluctuations can arise.

Such a thermal decoupling of the sensor adapter 39 can be established for example by a ceramic plate, as thermal insulator, integrated in the adapter housing 40 (and advantageously located in the region of the end 40″ facing away from the measuring arrangement 80). As an alternative or in addition, the sensor adapter 39 may be provided with a cooling device 90 which brings about a thermal decoupling between the process environment 5 and the housing interior space 21 and protects the components 81 in the housing interior space 21 against high thermal loads. For this, an exterior region 92 of the adapter housing 40 can be provided with a cooling line 91, for example a copper pipe, which annularly surrounds the exterior region 92 of the adapter housing 40 and through which a cooling liquid circulates; such a cooling line 91 is illustrated in FIG. 3b in dashed line. The cooling line 91 of the sensor adapter 39 may be connected to a cooling device of the housing 20 of the measuring arrangement 80. Advantageously, there the associated cooling coil is located directly underneath the component support 38, with the result that there is an air gap between the cooling coil and the base plate 24 of the housing 20. Such an air gap ensures good thermal insulation of the measuring arrangement 80 with respect to the base plate 24 and ensures good and efficient thermal regulation of the component support 38.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sensor adapter for connecting a plurality of sensors and/or actuators of different types located in a process environment to a measuring arrangement received in a housing and to provide a plurality of electrical, optical, electro-optical and/or pneumatic connection elements that are connectable to components of the measuring arrangement and via the measuring arrangement is adapted to be coupled to the plurality of sensors and/or actuators in the process environment, wherein the connection elements are integrated in connection modules positionally fixed in a fixing element in an interior space of the sensor adapter.

2. The sensor adapter as claimed in claim 1, wherein the fixing element comprises a fixing frame to receive one or more connection modules.

3. The sensor adapter as claimed in claim 2, wherein the one or more connection modules received in the fixing frame are part of a modular system of standard components.

4. The sensor adapter as claimed in claim 2, wherein the one or more connection modules have a standard width, and wherein the fixing frame has a cavity, a width of the cavity being adapted to a width of the one or more connection modules.

5. The sensor adapter as claimed in claim 1, wherein the sensor adapter comprises a connection plate for mechanical attachment of the sensor adapter to a housing of the measuring arrangement.

6. The sensor adapter as claimed in claim 1, wherein the sensor adapter comprises a terminating flange for mechanical attachment of the sensor adapter to a process environment.

7. The sensor adapter as claimed in claim 1, wherein the sensor adapter comprises a cooling device.

8. The sensor adapter as claimed in claim 6, wherein the cooling device comprises a cooling line through which a coolant is adapted to flow and which annularly surrounds an outer wall of the sensor adapter.

9. A method for producing a sensor adapter as claimed in claim 1, the method comprising:
selecting and fixing selected connection modules in the fixing frame of the fixing element;
positioning the fixing element in an interior space of the sensor adapter; and
at least partially filling the interior space of the sensor adapter with a potting compound.

10. The method as claimed in claim 9, wherein, while the fixing element is being positioned, a mounting aid is used to positionally align the fixing element in the interior space of the sensor adapter.

11. An analysis device to determine at least one characteristic of a medium, comprising a measuring arrangement with at least two components that are located in an interior space of a housing, wherein the housing has at least one inlet/outlet region for electric, optical, electro-optical and/or pneumatic lines, and wherein the analysis device comprises the sensor adapter as claimed in claim 1, which is adapted to be detachably fastened in the inlet/outlet region to the housing.

12. The analysis device as claimed in claim 11, wherein the housing of the analysis device comprises a cooling device, which is adapted to be coupled to a cooling device of the sensor adapter.
